(19) United States
(12) Patent Application Publication
(10) Pub. No.: US 2008/0178711 A1
(43) Pub. Date: Jul. 31, 2008

(54) Lock washer installation tool

(75) Inventors: Jonathan C. Heath, Mesa, AZ (US); James M. Lynn, Mesa, AZ (US)

Correspondence Address: Boeing (TLG);c/o Toler Law Group, 8500 Bluffstone Cove, Suite A201, Austin, TX, 78759, US

(73) Assignee: The Boeing Company

(21) Appl. No.: 11/698,671

(22) Filed: Jan. 25, 2007

(51) Int. Cl. B25B 7/02

(52) U.S. Cl. 81/415

(57) ABSTRACT

In an exemplary, non-limiting embodiment, a lock washer installation tool includes first and second handles that are rotatable about a pivot point. First and second opposable jaws are attached to the first and second handles. The first and second jaws are laterally spaced apart from each other, and the first and second opposable jaws are movable toward each other and away from each other responsive to rotation of the first and second handles about the pivot point. A holder is attached to the first jaw, and the holder is configured to receive and hold therein a lock washer.

### BACKGROUND

Difficulties can be experienced in installing a lock washer via an interference fit over a shank of a fastener. One attempt to address this problem involves using a hammer and socket to pound the lock washer over the shank of the fastener. However, shock from the pounding can cause damage to a workpiece, or can cause the lock washer to not sit flat on the workpiece, or can cause the lock washer to break during installation.

Another attempt to address this problem involves use of a lock washer installation tool available from the Camloc company as part number T98-1. The tool includes a socket-like receptacle at one end of the tool and a cushion grip (with a fairly small diameter) covering the other end of the tool. In using this tool, a lock washer is set on a shank of a fastener. The socket-like receptacle of the tool is placed over the lock washer and the shank of the fastener. A user pushes down on the cushion grip to force the washer over the shank of the fastener. However, substantial force must be exerted by a user onto a the fairly small diameter of the cushion grip, thereby possibly inducing fatigue to hands and shoulders of users. Moreover, use of the tool does not facilitate a flush condition after the lock washer has been installed, thereby possibly providing for improper load transfer from the fastener to a workpiece which could, in turn, lead to possible stress risers and/or possible premature failure of the fastener. Further, use of the tool requires virtually unlimited access around the fastener.

The foregoing examples of related art and limitations associated therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems and methods which are meant to be exemplary and illustrative, not limiting in scope. In various embodiments, one or more of the problems described above in the Background have been reduced or eliminated, while other embodiments are directed to other improvements.

In an exemplary, non-limiting embodiment, a lock washer installation tool includes first and second handles that are rotatable about a pivot point. First and second opposable jaws are attached to the first and second handles. The first and second jaws are laterally spaced apart from each other, and the first and second opposable jaws are movable toward each other and away from each other responsive to rotation of the first and second handles about the pivot point. A holder is attached to the first jaw, and the holder is configured to receive and hold therein a lock washer.

According to an aspect, the holder may define a tapered surface configured to receive thereon a lock washer having a taper corresponding to the tapered surface.

According to another aspect, the holder may be rotatably attached to the first jaw. Alternately, the holder may be non-rotatably attached to the first jaw.

According to another aspect, the holder may be magnetized.

According to another aspect, the holder may be selectable from a plurality of holders of a plurality of sizes.

According to another aspect, if desired a biasing device may be disposed between the first and second handles and configured to urge the first and second jaws away from each other. If provided, the biasing device may include a spring, a piston, a cam, a rubber O-ring, memory wire, or the like.

According to another aspect, the first and second handles each may define a first slot through which the pivot point is movable, such that lateral spacing between the first and second jaws is adjustable.

According to another aspect, the second jaw may define a second slot toward an end distal from the second handle, the second slot being configured to receive therein a shank of a fastener.

In an exemplary method of installing a lock washer using an exemplary lock washer installation tool, a shank of a fastener is received in a hole of a grommet that is installed in a workpiece. A lock washer is placed into a holder that is attached to a first jaw of a tool having a pair of handles. The lock washer is held in the holder, such as without limitation by magnetism. The tool is positioned such that the lock washer receives the shank of the fastener on a first side of the workpiece and a second jaw of the tool is positioned on a second side of the workpiece. The first and second jaws are urged toward each other, such as by squeezing the pair of handles, such that the lock washer is seated onto the shank of the fastener.

In addition to the exemplary embodiments and aspects described above, further embodiments and aspects will become apparent by reference to the drawings and by study of the following detailed description.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a perspective view of an exemplary lock washer installation tool;

FIGS. 2A and 2B illustrate details of the lock washer installation tool of FIG. 1;

FIG. 3 illustrates further details of an exemplary lock washer installation tool;

FIGS. 4A-4F illustrate stages of installation of a lock washer using an exemplary lock washer installation tool;

FIGS. 5A and 5B illustrate features of other exemplary lock washer installation tools; and

FIG. 6 illustrates features of another exemplary lock washer installation tool.

### DETAILED DESCRIPTION

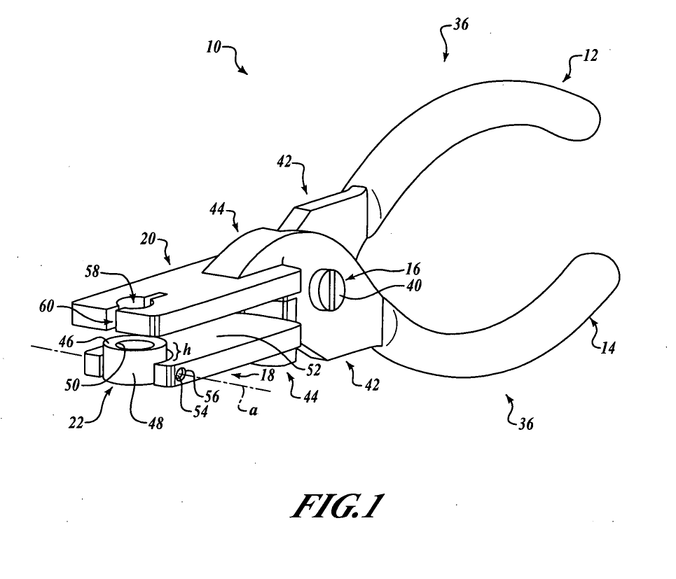

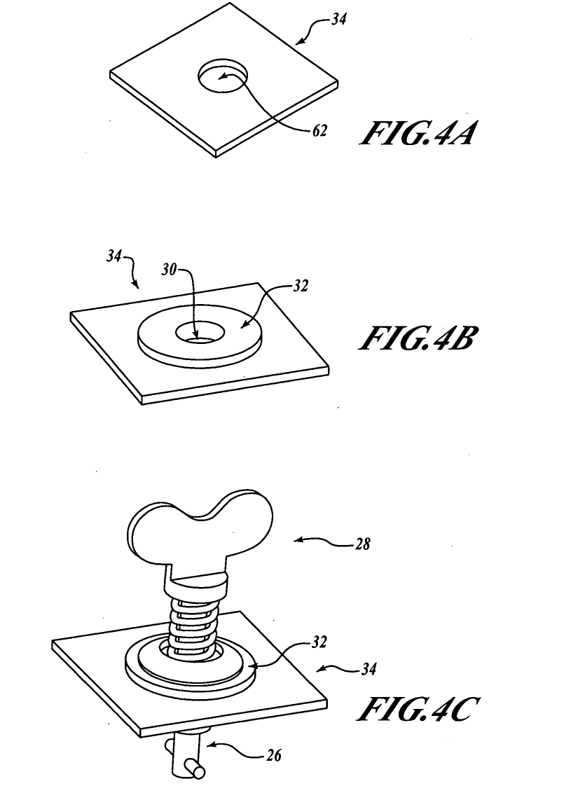

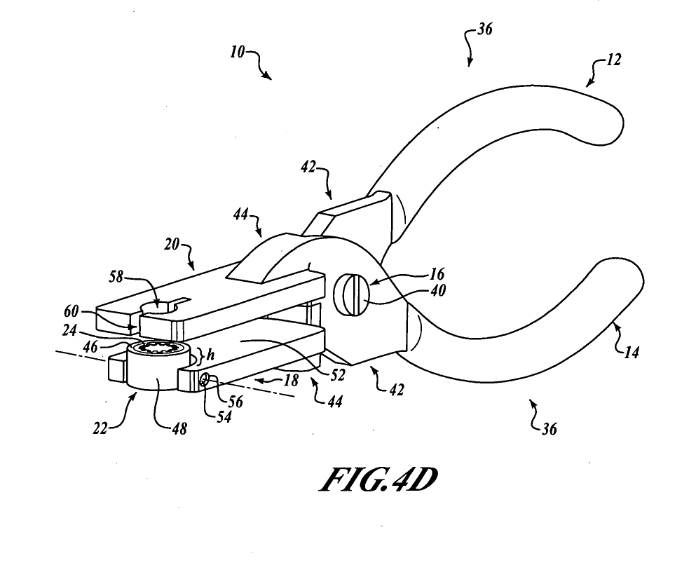

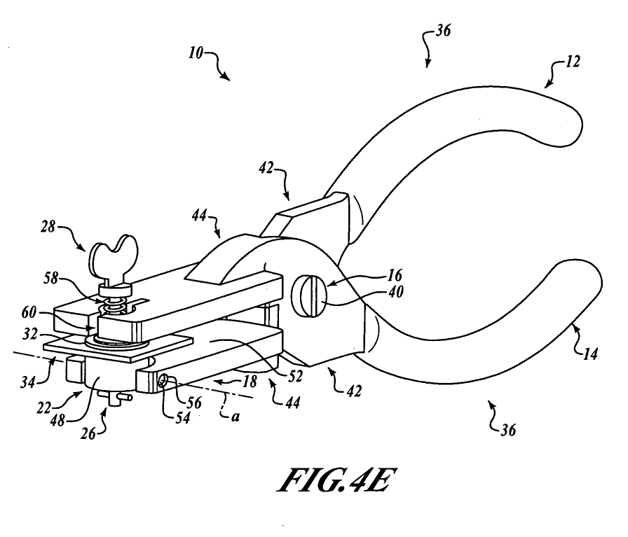

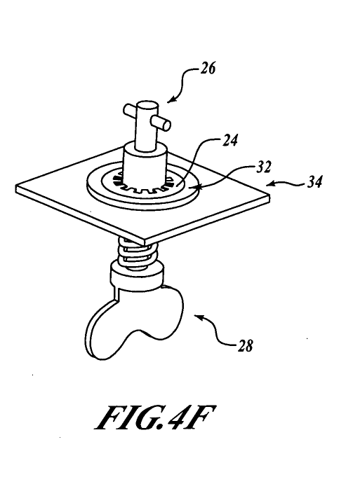

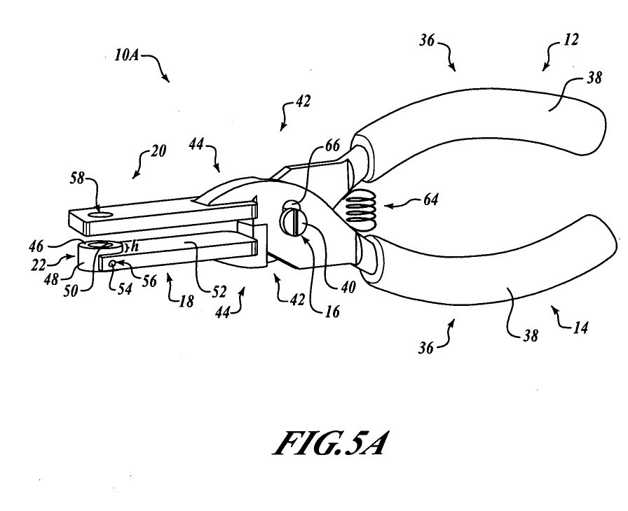

Given by way of overview and non-limiting example and referring to FIGS. 1 and 4A-4F, an exemplary lock washer installation tool 10 includes handles 12 and 14 that are rotatable about a pivot point 16. Opposable jaws 18 and 20 are attached to the handles 12 and 14. The jaws 18 and 20 are laterally spaced apart from each other, and the jaws 18 and 20 are movable toward each other and away from each other responsive to rotation of the handles 12 and 14 about the pivot point 16. A holder 22 is attached to the jaw 18, and the holder 22 is configured to receive and hold therein a lock washer 24 (FIG. 4D).

Still given by way of overview and non-limiting example and referring to FIGS. 4A-4F, in an exemplary method of installing the lock washer 24 using the exemplary lock washer installation tool 10, a shank 26 of a fastener 28 is received in a hole 30 of a grommet 32 that is installed in a workpiece 34. The lock washer 24 is placed into the holder 22. The lock washer 24 is held in the holder 22, such as without limitation by magnetism. The tool 10 is positioned such that the lock washer 24 receives the shank 26 of the fastener 28 on a first side of the workpiece 34 and the jaw 20 is positioned on a second side of the workpiece 34. The jaws 18 and 20 are urged toward each other, such as by squeezing the handles 12 and 14, such that the lock washer 24 is seated onto the shank 26 of the fastener 28. Details will now be explained below.

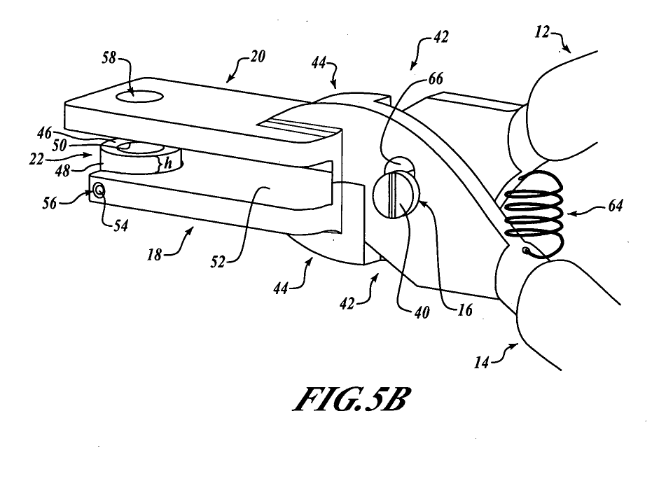

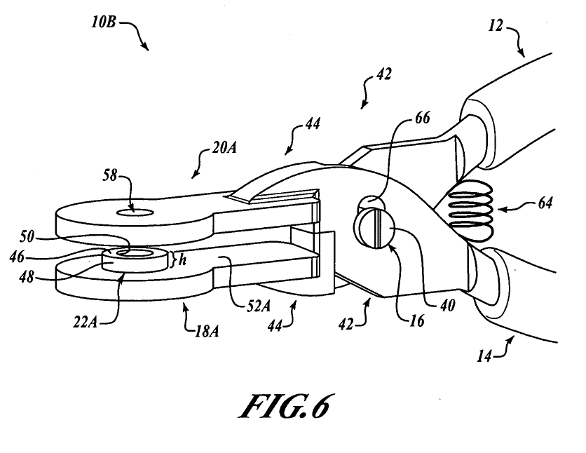

Referring now to FIGS. 1 and 4D, the tool handles 12 and 14 include a gripping portion 36 that a user squeezes to exert leverage and rotate the handles 12 and 14, thereby urging the jaws 18 and 20 toward each other. The handles 12 and 14 suitably may be large, comfort-grip type handles. The handles 12 and 14 may be coated with a rubber-type material to conform to a shape of a user's hand, thereby helping to reduce fatigue. Use of large, comfort-type grip handles may help to increase leverage when a user squeezes the gripping portion 36 of the handles 12 and 14, thereby helping reduce effort expended to overcome an interference fit of the lock washer 24 onto the shank 26. Further, use of large, comfort-grip type handles may help to reduce pinching of a user's palm when a user squeezes the gripping portion 36 of the handles 12 and 14. If desired, and referring briefly to FIG. 5A, the gripping portion 36 of the handles 12 and 14 may be covered with a covering 38, such as a cushioning foam like a polymer foam or the like, to provide additional cushioning for a user's palm when a user squeezes the gripping portion 36 of the handles 12 and 14.

Referring back to FIGS. 1 and 4D, the handles 12 and 14 are rotatable about the pivot point 16. The pivot point 16 may be provided in any known, acceptable manner. For example, a fastener 40 may be received in holes (not shown) in a pivot portion 42 of the handles 12 and 14.

The handles 12 and 14 may be made of any material as desired, such as steel, titanium, composites, and the like, that provides sufficient strength characteristics to withstand forces exerted on the handles 12 and 14 when the handles 12 and 14 are squeezed. Consideration may be given to use of the same material for the fastener 40 as the handles 12 and 14 (or an electrically compatible material) in order to reduce possibility of dissimilar metal corrosion.

The jaws 18 and 20 are attached to the handles 12 and 14, respectively, at an attachment portion 44 of the of the handles 12 and 14 that is on the other side of the pivot point 16 (and the attachment portion 42) as the gripping portion 36. The jaws 18 and 20 are laterally spaced apart from each other, thereby accommodating varying thickness of different workpieces. The jaws 18 and 20 are opposable. That is, the jaws 18 and 20 are movable toward each other and away from each other responsive to rotation of the handles 12 and 14 about the pivot point 16.

The jaws 18 and 20 may have any shape as desired for a particular application. To that end, shapes of the jaws 18 and 20 as depicted herein are illustrative and are not intended to be limiting whatsoever. Given by way of non-limiting example, and still referring to FIGS. 1 and 4D, the jaws 18 and 20 suitably may be substantially rectangular, substantially planar members. Referring briefly to FIG. 6, the jaws 18 and 20 may have a rounded end, if desired, to help provide access to tight spaces. Referring back to FIGS. 1 and 4D, the jaws 18 and 20 each have a thickness that is thick enough to provide sufficient strength to withstand forces imparted to the jaws 18 and 20 when the handles 12 and 14 are squeezed to install a lockwasher.

The jaws 18 and 20 each may be made from, and as part of, a same piece of material as their respective handles 12 and 14, such as by casting or forging. Alternately, the jaws 18 and 20 may be separate members that are attached to the attachment portions of the handles 12 and 14, respectively, such as by welding. In this case, the jaws 18 and 20 may be made of any material as desired, such as steel, titanium, composites, and the like, that provides sufficient strength characteristics to withstand forces imparted to the jaws 18 and 20 when the handles 12 and 14 are squeezed to install a lockwasher. Consideration may be given to use of the same material for the jaws 18 and 20 as the handles 12 and 14 (or an electrically compatible material) in order to reduce possibility of dissimilar metal corrosion.

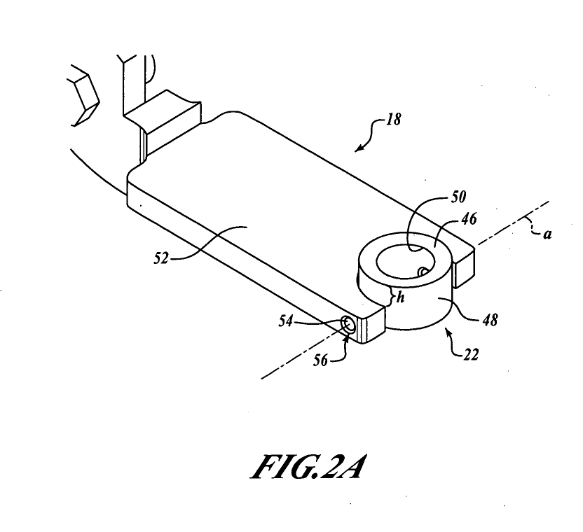

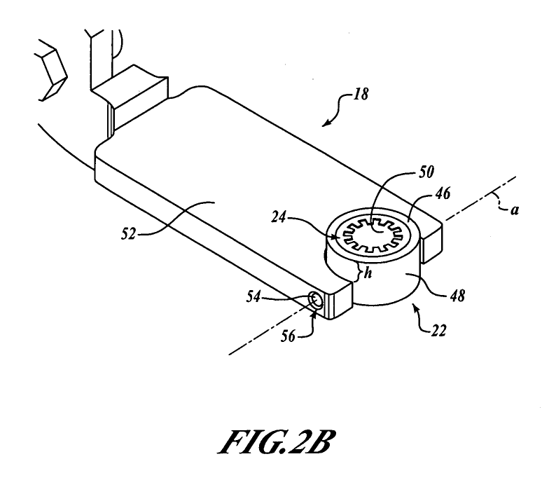

Referring additionally to FIGS. 2A and 2B, the holder 22 is attached to the jaw 18 and is configured to receive and hold therein the lock washer 24. The holder 22 suitably is a cylinder having a cylindrical opening extending completely therethrough, thereby permitting the shank 26 of the fastener 28 to be received in and extend through the holder 22 as the lock washer 24 is pressed onto the shank 26. A tapered face 46 is chamfered downwardly from an outer surface 48 at the top of the holder 22 toward an inner surface 50 of the holder 22. The tapered face 46 is chamfered to match a taper of the lock washer 24. This matching chamfer helps to hold the lock washer 24 in the holder 22. The matching chamfer also helps provide support to the stiffest part of the lock washer 24, thereby allowing the lock washer 24 to be installed with reduced possibility of deformation or damage to its locking tabs.

The holder 22 may be made in any size as desired to be able to receive and hold any size lock washer. Further, the tapered face 46 may be chamfered as desired to match a taper of any size lock washer. Thus, the holder 22 may be selected from a set of several of holders of varying sizes and chamfers that correspond to lock washers of varying sizes.

The top of the holder 22 suitably extends a height h above an upper face 52 of the jaw 18. This height difference permits installing a lock washer over protrusions, such as beads, bends, flanges, or the like, extending outwardly from a surface of a workpiece.

The holder 22 may be made of any material as desired. If desired, the holder 22 may be made of material, such as steel, that can be magnetized. When the holder 22 is magnetized, magnetism of the holder 22 can help hold the lock washer 22 in the holder.

If desired, the holder 22 may be rotatably attached to the jaw 18. Rotatability of the holder 22 allows the plane of the lock washer 24 held therein to be aligned with the plane of the workpiece 34, thereby permitting the lock washer 24 to be pressed flat against the workpiece 34. Rotatability of the holder 22 also facilitates accommodating workpieces of varying thicknesses. The holder 22 may be attached via pins 54 that are rotatably received in holes 56 at an end of the jaw 18 that is distal the handle 12. This rotatable attachment permits the holder 22 to rotate about an axis a.

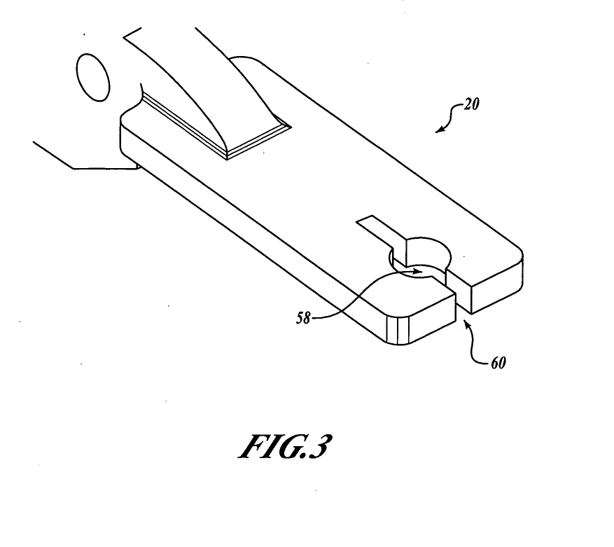

Referring now to FIG. 3, the jaw 20 defines a hole 58 therethrough toward an end distal the handle 14. The hole 58 suitably is sized to sit on a shoulder of the fastener 28 but allow clearance for the shank 26 of the fastener 28. If desired, and in addition to the hole 58, a slot 60 can be defined in the jaw 20 from the end distal the handle 14 through the hole 58 and, if desired, past the hole 58 toward the handle 14. The slot 60 permits accommodating various types of fasteners.

Referring now to FIGS. 4A through 4F, the tool 10 may be used as follows to install the lock washer 24. Referring to FIG. 4A, a hole 62 is drilled in the workpiece 34, such as a panel or the like. Referring to FIG. 4B, the grommet 32 (that defines the hole 30) is installed in the workpiece 34. Referring to FIG. 4C, the shank 26 of the fastener 28 is received in the hole 30 of the grommet 32.

Referring to FIG. 4D, the lock washer 24 is placed onto the tapered face 46 of the holder 22. When the holder 22 is magnetized, the lock washer 24 may be held in the holder 24 by magnetism. Referring to FIG. 4E, the tool 10 is positioned (that is, slipped over the workpiece 34 and the fastener 28) such that the lock washer 24 receives the shank 26 of the fastener 28 on a first side of the workpiece 34 and the jaw 20 is positioned on a second side of the workpiece 34 such that the fastener 28 is received through the hole 58 and, if provided, the slot 60. The handles 12 and 14 are squeezed, thereby urging the jaws 18 and 20 toward each other. This causes the lock washer 24 to be pressed onto the shank 26 of the fastener 28. The handles 12 and 14 are squeezed until the lock washer 24 is seated, via an interference fit, onto the shank 26 against the grommet 32. Referring now to FIG. 4F, the lock washer 24 has been fully seated.

Referring now to 5A and 5B, several additional non-limiting features are illustrated. A lock washer installation tool 10A includes many of the same features as the tool 10, and like reference numbers are shown to refer to the same features. Details regarding the same features already discussed for the tool 10 will not be repeated for sake of brevity. In addition, the covering 38 has already been described above and repetition of its details is not necessary for an understanding. Any one or more of the features of the tool 10A can be incorporated in the tool 10, as desired for a particular application.

A biasing device 64 may be disposed between the handles 12 and 14. If provided, the biasing device 64 is configured to urge the jaws 18 and 20 away from each other. That is, the biasing device 64 can help keep the jaws 18 and 20 open. The biasing device 64 may be provided as a spring, a piston (not shown), a cam (not shown), a rubber O-ring (not shown), memory wire (not shown), or the like.

The handles 12 and 14 each may define in their pivot portions 42 a slot 66 through which the pivot point 16 is movable. In such a case, the fastener 40 is able to slide up and down through the slot 66. Such movement of the pivot point 16 provides for increased adjustment of lateral spacing between the jaws 18 and 20. This increased adjustment permits accommodating thicker workpieces than can be accommodated without the slot 66.

Referring now to FIG. 6, further additional non-limiting features are illustrated. A lock washer installation tool 10B includes many of the same features as the tool 10 and the tool 10A, and like reference numbers are shown to refer to the same features. Details regarding the same features already discussed for the tool 10 and the tool 10A will not be repeated for sake of brevity. Any one or more of the features of the tool 10B can be incorporated in the tool 10, as desired for a particular application.

As discussed above, the jaws 18A and 20A may have a rounded end, if desired, to help provide access to tight spaces.

If desired, a holder 22A may be non-rotatably attached to the jaw 18A. The holder 22A includes chamfering of the tapered face 46 from the outer surface 48 to the inner surface 50 as described above for the holder 22. the holder 22A extends the height h above an upper face 52A of the jaw 18A. In addition, the holder 22A may be made of the same materials as the holder 22 and, if desired, may be magnetized as discussed above. The holder 22 may be fixedly attached (such as by welding) or removably attached (such as being threadedly received in an appropriately sized threaded hole in the jaw 18A) to the jaw 18A. Alternately, the holder 22A may be machined as part of the jaw 18A. Regardless of attachment or machining of the holder 22A, the hole inside the holder 22A extends completely though the jaw 18A. The non-rotatable holder 22A provides for more simplified fabrication and attachment than that of the holder 22. When the non-rotatable holder 22A is provided, consideration may be given to also including the slot 66. In cases where the non-rotatable holder 22A is provided, movement of the pivot point 16 also provides for alignment of the holder 22A with the shank 26 of the fastener 28.

While a number of exemplary embodiments and aspects have been illustrated and discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

What is claimed is:

1. A lock washer installation tool comprising:
first and second handles that are rotatable about a pivot point;
first and second opposable jaws attached to the first and second handles, the first and second jaws being laterally spaced apart from each other, the first and second opposable jaws being movable toward each other and away from each other responsive to rotation of the first and second handles about the pivot point;
a holder attached to the first jaw, the holder being configured to receive and hold therein a lock washer.

2. The tool of claim 1, wherein the holder defines a tapered surface configured to receive thereon a lock washer having a taper corresponding to the tapered surface.

3. The tool of claim 1, wherein the holder is rotatably attached to the first jaw.

4. The tool of claim 1, wherein the holder is magnetized.

5. The tool of claim 1, further comprising a biasing device disposed between the first and second handles and configured to urge the first and second jaws away from each other.

6. The tool of claim 5, wherein the biasing device includes a biasing device chosen from a spring, a piston, a cam, a rubber O-ring, and memory wire.

7. The tool of claim 1, wherein the first and second handles each define a first slot through which the pivot point is movable, such that lateral spacing between the first and second jaws is adjustable.

8. The tool of claim 7, wherein the holder is non-rotatably attached to the first jaw.

9. The tool of claim 1, wherein the second jaw defines a second slot toward an end distal from the second handle, the second slot being configured to receive therein a shank of a fastener.

10. The tool of claim 1, wherein the holder is selectable from a plurality of holders of a plurality of sizes.

11. A lock washer installation tool comprising:
first and second handles that are rotatable about a pivot point;
first and second opposable jaws attached to the first and second handles, the first and second jaws being laterally spaced apart from each other, the first and second opposable jaws being movable toward each other and away from each other responsive to rotation of the first and second handles about the pivot point;
a holder rotatably attached to the first jaw, the holder defining a tapered surface configured to receive thereon a lock washer having a taper corresponding to the tapered surface.

12. The tool of claim 11, wherein the holder is magnetized.

13. The tool of claim 11, further comprising a biasing device disposed between the first and second handles and configured to urge the first and second jaws away from each other.

14. The tool of claim 13, wherein the biasing device includes a biasing device chosen from a spring, a piston, a cam, a rubber O-ring, and memory wire.

15. The tool of claim 11, wherein the first and second handles each define a first slot through which the pivot point is movable, such that lateral spacing between the first and second jaws is adjustable.

16. The tool of claim 11, wherein the second jaw defines a second slot toward an end distal from the second handle, the second slot being configured to receive therein a shank of a fastener.

17. The tool of claim 11, wherein the holder is selectable from a plurality of holders of a plurality of sizes.

18. A lock washer installation tool comprising:
first and second handles that are rotatable about a pivot point;
first and second opposable jaws attached to the first and second handles, the first and second jaws being laterally spaced apart from each other, the first and second opposable jaws being movable toward each other and away from each other responsive to rotation of the first and second handles about the pivot point;
a holder non-rotatably attached to the first jaw, the holder defining a tapered surface configured to receive thereon a lock washer having a taper corresponding to the tapered surface.

19. The tool of claim 18, wherein the holder is magnetized.

20. The tool of claim 18, further comprising a biasing device disposed between the first and second handles and configured to urge the first and second jaws away from each other.

21. The tool of claim 20, wherein the biasing device includes a biasing device chosen from a spring, a piston, a cam, a rubber O-ring, and memory wire.

22. The tool of claim 18, wherein the first and second handles each define a first slot through which the pivot point is movable, such that lateral spacing between the first and second jaws is adjustable.

23. The tool of claim 18, wherein the second jaw defines a second slot toward an end distal from the second handle, the second slot being configured to receive therein a shank of a fastener.

24. The tool of claim 18, wherein the holder is selectable from a plurality of holders of a plurality of sizes.

25. A method of installing a lock washer, the method comprising:
receiving a shank of a fastener in a hole of a grommet that is installed in a workpiece;
placing a lock washer into a holder that is attached to a first jaw of a tool having a pair of handles;
positioning the tool such that the lock washer receives the shank of the fastener on a first side of the workpiece and a second jaw of the tool is positioned on a second side of the workpiece; and
urging the first and second jaws toward each other such that the lock washer is seated onto the shank of the fastener.

26. The method of claim 25, wherein urging the first and second jaws toward each other includes squeezing the pair of handles.

27. The method of claim 25, wherein the lock washer is seated with an interference fit.

28. The method of claim 25, wherein placing the lock washer into the holder includes holding the lock washer in the holder.

29. The method of claim 28, wherein:
the holder is magnetized; and
the lock washer is held in the magnetized holder by magnetism.

30. The method of claim 25, wherein:
the holder is rotatably attached to the first jaw of the tool; and
positioning the tool includes rotating the holder such that the lock washer is aligned to receive therein a shank of a fastener.

31. The method of claim 25, wherein positioning the tool includes adjusting lateral separation between the first and second jaws such that the first and second jaws are positioned on the first and second sides of a workpiece, respectively.
